(19) United States
(12) Patent Application Publication
(10) Pub. No.: US 2003/0086444 A1
(43) Pub. Date: May 8, 2003

(54) Voice/tone discriminator

(75) Inventors: Matthew Randmaa, Santa Barbara, CA (US); Vasudev S. Nayak, Santa Barbara, CA (US); Chuan Hsueh, Santa Barbara, CA (US)

Correspondence Address: HUNTON & WILLIAMS, INTELLECTUAL PROPERTY DEPARTMENT, 1900 K STREET, N.W., SUITE 1200, WASHINGTON, DC, 20006-1109, US

(73) Assignee: Globespan Virata, Incorporated

(21) Appl. No.: 10/254,970

(22) Filed: Sep. 26, 2002

Related U.S. Application Data
(60) Provisional application No. 60/325,157, filed on Sep. 28, 2001.

(51) Int. Cl. H04J 3/12

(52) U.S. Cl. 370/526; 379/418

(57) ABSTRACT

The present invention is directed to a voice tone discriminator for distinguishing between call progress tones and voice. The voice tone discriminator is useful in various applications involving the ability to automatically charge a telephone user based on the exact time the user starts speaking. According to another aspect of the present invention, a prediction algorithm may be implemented for distinguishing voice and tone based on the fact that tones are more accurately modeled with a linear filter than voice signals. Thus, a low order filter or predictor may accurately model redundancies in tones but not in voice. A normalized error between an original and a predicted signal may be used to distinguish voice from tones. Voice may be detected when the error is above a preset threshold for a time greater than a preset fixed duration.

### CROSS-REFERENCE TO RELATED APPLICATIONS

This patent application claims priority to U.S. Provisional Patent Application No. 60/325,157, filed Sep. 28, 2001, which is hereby incorporated by reference in its entirety.

### FIELD OF THE INVENTION

The present invention relates generally to voice/tone discriminators, more particularly, to a method and system for discriminating voice signals and tone signals using a normalized error signal representing a difference between a prediction signal generated by an adaptive prediction filter for modeling a tone signal and an input signal comprising voice and tone signals.

### BACKGROUND OF THE INVENTION

Various types of voice related applications are available for users with varying needs. For example, telephony, Voice over Digital Subscriber Line (VoDSL), Voice over Internet Protocol (VoIP) as well as other voice applications provide enhanced communications among users. These applications provide voice transmission that is clearer, faster and cheaper. Other advantages are also available for users of varying needs and concerns.

VoDSL involves leveraging copper infrastructure to provide quality voice services and support a wide variety of data applications over an existing line to a customer. VoDSL implements Digital Subscriber Line (DSL) platform in conjunction with platform adaptations that enable voice services. It further gives data competitive local exchange carriers (CLECs) a way to increase revenue potential, incumbent local exchange carriers (ILECs) an answer to the cable modem, and interexchange carriers (IXCs) a way to gain access to the local voice loop. Thus, any carrier type may increase the value of services available through VoDSL.

Generally, VoDSL involves a voice gateway, an integrated access device (IAD) and other components. The voice gateway may provide voice packets that are depacketized and converted to a format for delivery to a voice switch or other device. The voice gateway may enable traffic to be accessed from a data network and forwarded to public switched telephone network (PSTN) for service and switching. The IAD may serve as a DSL modem and perform other functionality. The IAD may serve as an interface between a DSL network service and a customer's voice and data equipment. The IAD may provide the interface between the DSL network service and a customer's network equipment. Further, an IAD may be used to connect voice and data enabled equipment.

VoDSL may also be transmitted via Internet Protocol (IP). VoIP may be defined as voice over Internet Protocol, which includes any technology that enables voice telephony over IP networks. Some of the challenges involved with VoIP may include delivering voice, fax or video packets in a dependable manner to a user. This may be accomplished by taking the voice or data from a source where it is digitized, compressed due to the limited bandwidth of the Internet, and sent across the network. The process may then be reversed to enable communication by voice. VoIP enables users, including companies and other entities, to place telephony calls over IP networks, instead of public switched telephone networks.

Service providers and other entities desire a way to accurately determine the start and end of a voice communication session. Calls should be billed as soon as a customer starts talking. If speech is not properly detected, customers may be billed erroneously based on a call progress tone. This results in higher phone charges for customers based on inaccurate voice detection.

Traditional voice discriminators implement auto correlation to differentiate between voice and voiceband data (e.g., fax/modem data) in an input signal from a voiceband channel. The discrimination is generally based upon computation of at least two characteristics of the input signal, which may include an autocorrelation function and a power variation function. These voice discriminators receive an input stationary data that is fax/modem.

Other conventional voice discriminators use an adaptive predictor and other techniques where discrimination is directed to a specific group of voice data namely, Phase Shift Keying (PSK) and Quadrature Amplitude Modulation (QAM). In this case, an adaptive predictor is used only to generate coefficients that show specific values. In other words, there is an assumption made on the nature of input data for prediction. Further, the focus is generally on detecting speech and specific PSK and QAMs. The discrimination between voiceband data and speech may be based on a short-time energy, a zero-crossing rate and coefficients of an adaptive predictor.

In traditional voice discriminators, an assumption is generally made regarding the nature of a signal. For example, the frequency spectrum input may be assumed. Other assumptions may concern the type of signal, such as a fax/modem input signal.

Therefore, there is a need in the art of voice/tone discrimination for a more efficient method and system for discriminating between voice and tone signals.

### SUMMARY OF THE INVENTION

Aspects of the present invention overcome the problems noted above, and realize additional advantages. One such inventive aspect provides a voice tone discriminator for distinguishing between call progress tones and voice wherein the voice tone discriminator is useful in various applications involving the ability to automatically charge a telephone user based on the exact time the user starts speaking.

According to another aspect of the present invention, a prediction algorithm may be implemented for distinguishing voice and tone based on the fact that tones are more accurately modeled with a linear filter than voice signals. Thus, a low order filter or predictor may accurately model redundancies in tones but not in voice. A normalized error between an original and a predicted signal may be used to distinguish voice from tones. Voice may be detected when the error is above a preset threshold for a time greater than a preset fixed duration.

According to an exemplary embodiment of the present invention, a method for discriminating voice from tone comprises the steps of: receiving an input signal; generating a prediction signal for modeling a signal wherein the signal is one of a tone signal and a speech signal; comparing the input signal and the prediction signal; generating an error signal based on the input signal and the prediction signal; and detecting a voice signal when the error signal is above a predetermined threshold value.

In accordance with other aspects of the exemplary embodiment of the present invention, the method further comprising the steps of determining a duration associated with the error signal and determining whether the duration is above a predetermined time threshold for detecting the voice signal; the predetermined time threshold is approximately 128 milliseconds; the method further comprises the step of determining a start of the voice signal; the error signal is a normalized error signal; the method further comprises the step of distinguishing a noise signal from the input signal; the method further comprises the step of implementing a noise floor of approximately 6 dB; the step of generating an error signal further comprises the steps of calculating a normalized mean square error value for each sample for each subframe and accumulating the normalized mean square error value for each sample for generating the error signal; each subframe comprises approximately 8 samples; the step of generating a predicted signal further comprises the step of implementing a normalized least mean square function; the error signal is computed as e′(n)=e(n)/rms(xₖ₋₁ . . . x_{k-M}) wherein e(n) is represented by d(n)−w(n)^{T} u(n), where d(n) represents a desired response, where w(n) represents predictor coefficients; where u(n) represents an input vector at time n where the input vector comprises xₖ₋₁ . . . x_{k-M}, and where M represents a number of taps; and wherein w(n+1) is represented by w(n)+μu(n)e*(n)/(a+∥u(n)∥²) where μ represents an adaptation constant; where a represents a positive constant.

According to another exemplary embodiment of the present invention, a system for discriminating voice from tone comprises a filter for receiving an input signal; a prediction filter for generating a prediction signal for modeling a signal wherein the signal is one of a tone signal and a speech signal; a module for comparing the input signal and the prediction signal and for generating an error signal based on the input signal and the prediction signal; wherein a voice signal is detected when the error signal is above a predetermined threshold value.

In accordance with other aspects of the exemplary embodiment of the present invention, the module determines a duration associated with the error signal and determines whether the duration is above a predetermined time threshold for detecting the voice signal; the predetermined time threshold is approximately 128 milliseconds; a start of the voice signal is determined; the error signal is a normalized error signal; the filter distinguishes a noise signal from the input signal; the filter implements a noise floor of approximately 6 dB; the module calculates a normalized mean square error value for each sample for each subframe, and accumulates the normalized mean square error value for each sample for generating the error signal; each subframe comprises approximately 8 samples; the prediction filter implements a normalized least mean square function; the error signal is computed as e′(n)=e(n)/rms(xₖ₋₁ . . . x_{k-M}) wherein e(n) is represented by d(n)−w(n)^{T} u(n), where d(n) represents a desired response, where w(n) represents predictor coefficients; where u(n) represents an input vector at time n where the input vector comprises xₖ₋₁ . . . x_{k-M}, and where M represents a number of taps; wherein w(n+1) is represented by w(n)+μu(n)e*(n)/(a+∥u(n)∥²) where μ represents an adaptation constant; where a represents a positive constant; and the prediction filter is an adaptive prediction filter.

The accompanying drawings, which are incorporated in and constitute a part of this specification, illustrate various embodiments of the invention and, together with the description, serve to explain the principles of the invention.

### BRIEF DESCRIPTION OF THE DRAWINGS

The present invention can be understood more completely by reading the following Detailed Description of the Invention, in conjunction with the accompanying drawings, in which:

FIG. 1 is a flowchart illustrating a method for discriminating between voice and tone, according to an embodiment of an aspect of the present invention.

FIG. 2 is a flowchart illustrating details of a method for discriminating between voice and tone, according to an embodiment of an aspect of the present invention.

FIG. 3 is a block diagram of a voice/tone discriminator, according to an embodiment of an aspect of the present invention.

FIG. 4 is a schematic drawing of a software architecture in which the inventive aspects of the present invention may be incorporated.

FIG. 5 is a schematic drawing of a software architecture in which the inventive aspects of the present invention may be incorporated.

FIG. 6 is a schematic drawing of a hardware architecture in which the inventive aspects of the present invention may be incorporated.

FIG. 7 is a schematic diagram of a hardware architecture in which the inventive aspects of the present invention may be incorporated.

FIG. 8 is a schematic diagram of a software architecture in which the inventive aspects of the present invention may be incorporated.

### DETAILED DESCRIPTION OF THE INVENTION

The following description is intended to convey a thorough understanding of the invention by providing a number of specific embodiments and details involving voice/tone discrimination applications. It is understood, however, that the invention is not limited to these specific embodiments and details, which are exemplary only. It is further understood that one possessing ordinary skill in the art, in light of known systems and methods, would appreciate the use of the invention for its intended purposes and benefits in any number of alternative embodiments, depending upon specific design and other needs.

The present invention provides a combination of hardware and software that may be integrated into a customer's product to enhance call progress tone versus voice discrimination. According to one aspect of the present invention, the voice/tone discriminator provides a technique for distinguishing between stationary signals and non-stationary signals. As one application may be intended for telephony and other related applications, input signals may be band limited to be voice band signals, which may be one assumption made by the present invention. The discrimination techniques of the present invention may be used in other non-voice application, as is fully contemplated by the present invention, and appropriate band limiting and other appropriate assumptions would be recognized by those skilled in the art.

The present invention provides a method and system for discriminating between voice band tones and voice. According to an aspect of the present invention, no assumption is made regarding the range of frequencies of the voice band tone. The present invention is capable of discriminating irrespective of voice band tone frequency. This discrimination may be based on a normalized error generated by an adaptive prediction error filter. The normalized error is different for stationary signals (e.g., tones) from that of non-stationary signals (e.g., speech).

The present invention may be implemented in telephony applications, VoIP or VoDSL applications as well as other applications. These and other applications may be concerned with billing calls as soon as a user starts talking. In addition, billing the user incorrectly based on a call progress tones may be avoided. The technique of the present invention may also be used in any other application where a periodic or stationary signal may be distinguished from a non-stationary signal.

The voice/tone discriminator of the present invention makes use of the fact that tones are more accurately modeled with a linear filter than voice signals. Such a filter may be obtained using a prediction algorithm. Thus, a low order filter or predictor may accurately model redundancies in tones but not in voice. A normalized error between an original signal and a predicted signal may be used to distinguish voice from tones. Voice may be detected when the error is above a preset threshold for a time greater than a preset fixed duration.

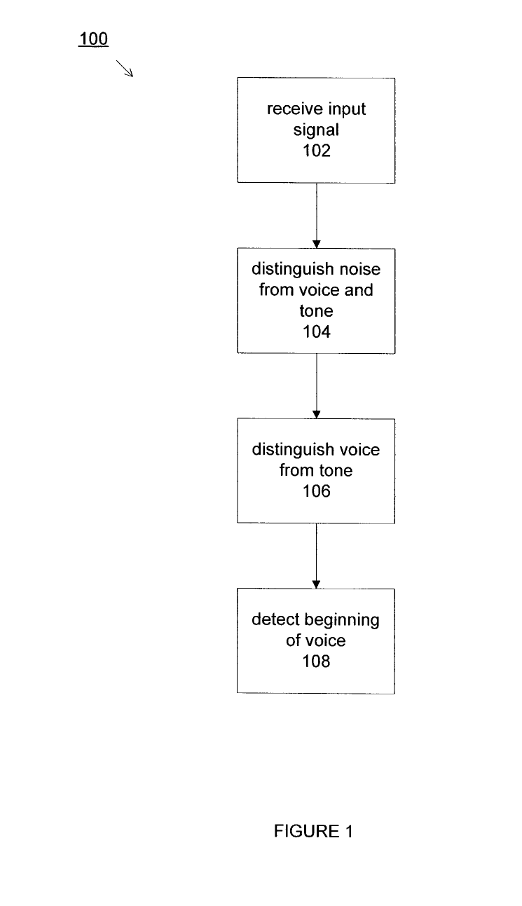

FIG. 1 is a flowchart illustrating a process 100 for discriminating between voice and tone, according to an embodiment of an aspect of the present invention. At step 102, an input signal is received. At step 104, noise is distinguished from voice and tone. At step 106, after the noise has been distinguished, the present invention distinguishes voice from tone. At step 108, the beginning of voice is detected. In one manner, the discriminator of the present invention applies a least mean square error technique to various signals, including noise, voice and tone for distinguishing these signals. The discriminator then implements an adaptive filter for determining whether a signal is voice or tone.

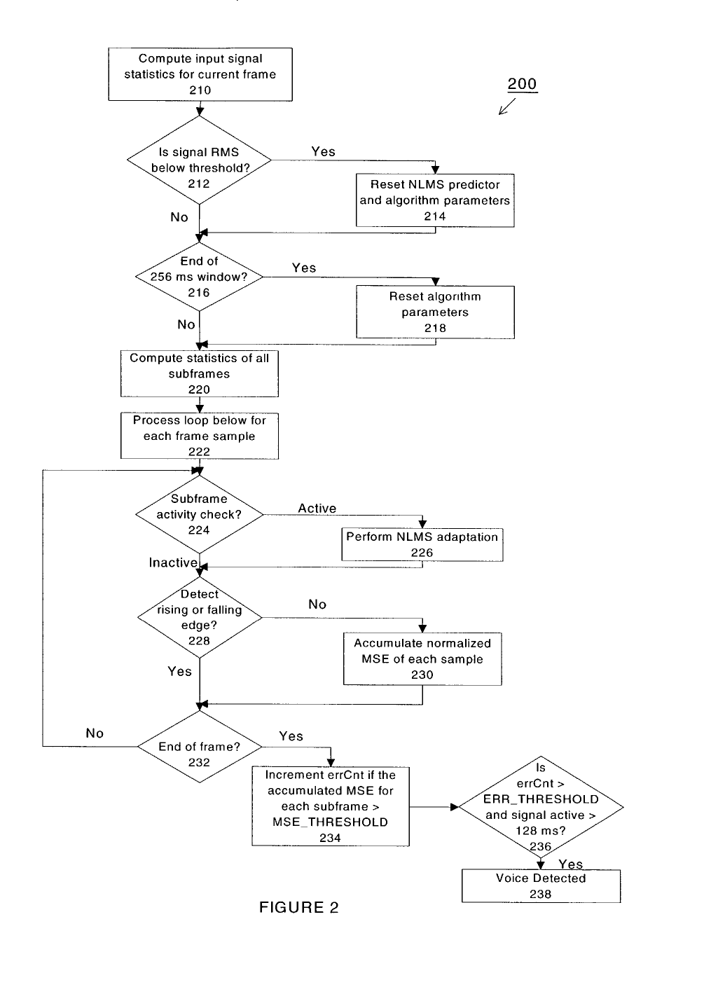

FIG. 2 is a flowchart illustrating details of a process 200 for discriminating between voice and tone, according to an embodiment of an aspect of the present invention. An input signal to a discriminator may include voice data. For example, the voice data may be sampled at 8 KHz and digitized to 16 bit fixed point 2's complement grouped in 64 sample frames. A subframe may have a size of 8 samples which amounts to 1 millisecond (ms). As the discriminator utilizes the randomness of voice as opposed to that of tones to discriminate, the voice may be at least 6 decibels (dB), for example, above the noise floor and the minimum voice level may be −46 decibels referenced as milliwatts (dBm). Other specifics may be implemented in accordance with the present invention.

At step 210, input signal statistics for a current frame may be computed. Input signal statistics may include noise floor and Root Mean Square (RMS). Other input signal statistics may be computed. In addition, noise may be distinguished from voice/tone. For example, any signal within 6 dB of a noise floor, for example, may be considered noise. If no signal is present for 24 ms (or other predetermined time frame), as determined by step 212, prediction filter parameters and algorithm parameters may be reset, at step 214.

According to an example of the present invention, determination of voice/tone may be accomplished within a window of 256 ms. Other windows may be applied. A window time count may be initialized when the sum of normalized squared errors above a preset threshold (MSE_THRESHOLD) is detected for the first time. An algorithm history may be reset after 256 ms, at step 218. For example, the algorithm history may include window time count, signal activity count and/or error count.

A subframe may be determined to be active if its RMS is above a fixed threshold, which may be set to −46 dBm. Other threshold values may be applied. Statistics of subframes of 1 ms may be computed, at step 220. For example, the RMS of each subframe may be calculated and its activity may be determined.

The following loop process may be initiated at step 222 and processed for each frame sample. At step 224, subframe activity may be checked. This check may be useful to prevent false adaptation. The adaptation may be performed, at step 226, if at least one of the previous, current or next subframes is active. The activity check results may also be used for edge detection.

At step 228, a rising or a falling edge may be detected. Edge detection may be useful to prevent tones/silences from being falsely determined as voice before the adaptation has converged. The edge may be detected when at least one of the previous, current or next subframes is inactive. In such a case, the error calculated may not be used in accumulation. If a rising or a falling edge is not detected, at step 228, normalized mean square error (MSE) of each sample may be accumulated separately for each subframe, at step 230. At step 232, an end of a frame may be determined. If a frame end is not detected, the above loop process may continue, at step 222.

If a frame end is detected, error accumulation and voice detection may be performed. There are at least two levels of threshold comparisons to ensure that voice is not falsely detected. The first level may involve a sum of the normalized squared errors between the predicted and the actual signal. This sum may be calculated by accumulating the normalized squared error of each sample for each subframe. This accumulated value may then be compared against a threshold (MSE_THRESHOLD), at step 234.

A second level may involve the diversification of error determination. A count of the number of such errors may be maintained and compared to another threshold (ERR_THRESHOLD) in the 256 ms window. Along with this comparison, another check may be performed to determine if the signal has been consecutively active for 128 ms, at step 236. The 128 ms count (or other time frame) may be implemented to ensure that short term disturbances do not cause false detections. For a signal to be determined voice, at step 238, the signal may have a high prediction error spread over at least 128 ms.

Although any adaptive function would be equally applicable to obtain a prediction filter, the present invention utilizes the Normalized Least Mean Square (NLMS) function for simplicity. In particular, the NLMS function exhibits a rate of convergence that is potentially faster than that of the standard LMS function for both uncorrelated and correlated input data. In the equations below the value in parentheses refer to the time and variables in bold refer to arrays (e.g., vec(n) refers to values of the array “vec” at time n).

Parameters:

M=number of taps

μ=an adaptation constant (0<μ<2)

a=a positive constant

Data:

w(0)=| appropriate value if known;

|0 otherwise;

u(n): M by 1 tap input vector at time n

d(n): Desired response at time n

e(n): Error at time n

Computation: n=0,1,2 . . .

e(n)=d(n)−w(n)^{T}u(n)

w(n+1)=w(n)+μu(n)e*(n)/(a+∥u(n)∥²)

If xₖ . . . x_{k-M} is the sequence of input samples then

d(n)=xₖ

u(n)=xₖ₋₁ . . . x_{k-M}

w(n)=predictor coefficients

e′(n)=e(n)/rms(xₖ₋₁ . . . x_{k-M}):e′(n) represents a normalized error, where the square of the error may be used for determining a signal type.

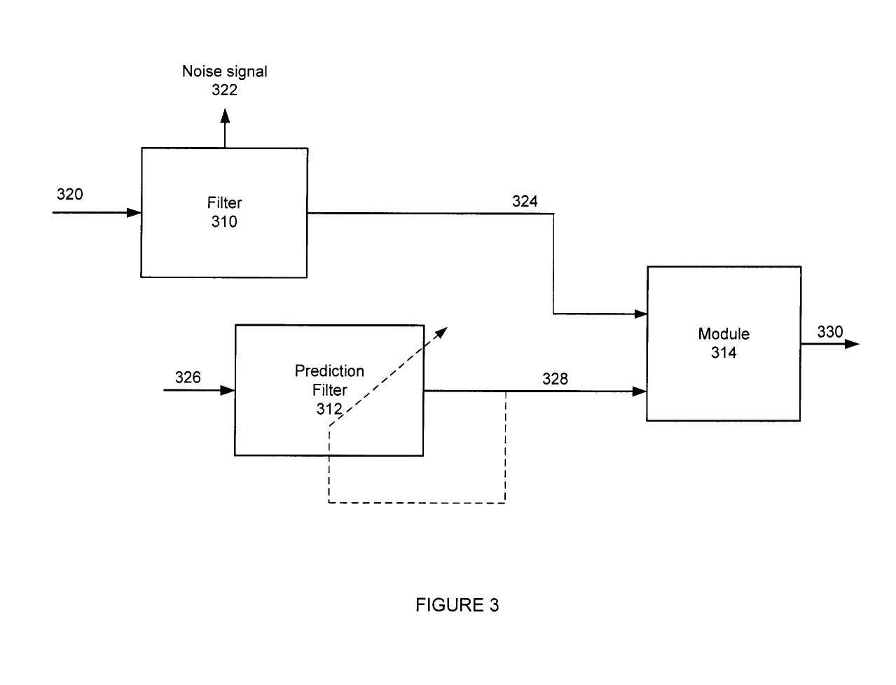

FIG. 3 is a block diagram of a voice/tone discriminator according to an embodiment of an aspect of the present invention. Filter 310 receives an input signal. Filter 320 may filter out a noise signal 322. This may be accomplished by implementing a noise floor. For example, any signal within 6 dB of the noise floor may be considered noise and filtered. A prediction filter 312 may generate a signal 328, which may be a tone signal or a speech signal, based on at least in part on an input, as shown by 326. Input 326 may be substantially similar to signal 324 or a modified version of signal 324. In this example, the prediction filter 312 may be adaptive. Signal 324 may be compared to prediction signal 328 by module 314. Module 314 may then generate an error signal 330, which may be a normalized error signal for distinguishing between voice and tone. For example, if the normalized error signal 330 is above a predetermined threshold for a predetermined time duration, it may be determined that voice is detected.

The aspects of the present invention may be implemented in the following exemplary code.

#include “stdio.h”
#include “comm.h”
#include “nfe.h”
#include “vtd.h”
void VTD_init(VTD_Handle vtd)
{

I16 i = 0;
I16 *fill_ptr = (I16 *)vtd;
for (i = 0; i<39; i++){

*(fill_ptr + i) = 0;

}

}
I32 VTD_run(VTD_Handle vtd NFE_Handle nfe)
{

I32 ms,acc,accb,normSh,sqNorm;
I16 errnt, i, j, k, p,levelSig;
I16 *xwork;
I16 rmsFlag[11],terrRms[9],errRms[9];
I32 msx[8];
rmsFlag[10] = 1;
rmsFlag[0] = vtd->rmsFlag0;
rmsFlag[1] = vtd->rmsFlag1;
sqNorm = (((132)vtd->sqNormH)<<16) + vtd->sqNormL;
xwork = vtd->src_ptr;
terrRms[0] = vtd->terrRms;
/* 6 db above noise floor */
levelSig = (nfe->sigmaNHatNomin >> 6) * 2;
levelSig = levelSig > 10 ? levelSig : 10;
ms = nfe->rms * nfe->rms;
if(nfe->rms < levelSig){

if(nfe->lrms < levelSig && vtd->prms < levelSig){

for(p=1; p<=ORDER;p++){

*(vtd>x+ORDER-p) = 0;
*(vtd>a+p) = 0;

}
vtd->errLms = 0;
sqNorm = 0;
vtd->blockActive = 0;
vtd->errCnt = 0;
vtd->sampleCnt =0;

}

}
vtd->blockActive++;
vtd->prms = nfe->lrms;
for (k = 0j = 2;j < 10;j++, k+=8){

xwork = vtd->src_ptr + k;
rmsFlag[j] =1;
errRms[j-2] = 0;
acc = 0;
for(i = 0; i < 8;i++){

acc += (*(xwork+i)) * (*(xwork+i));

}
if(acc >> 3 < ABSLEVEL){

rmsFlag[j] = 0;

}
normSh = (ace * 11) >> 13;
msx[j−2] = ((11 << 12)/((11+normSh) >> 2));

}
errRms[j−2] =0;
vtd->sampleCnt++;
if(vtd->sampleCnt == 32){

vtd->sampleCnt = 0;
vtd->errCnt = 0;
vtd->blockActive = 0;

}
for(k = 0; k < 64; k++)(

j = k >> 3;
accb = 0;
if(k==34){

k = 34;

}
/*
* Last current or next subframe present do LMS
*/
if((rmsFlag[j+1)]) || (rmsFlag[(j+2)]) || (rmsFlag[(j+3)])){

*(vtd->x+ORDER) = vtd->prevVal;
/* Lets try Q14 for a and consier x as Q15 and errLms should be Q15*/
acc = -((vtd->errLms) * (*(vtd->x+ORDER−1)));
for(accb = *(vtd->src_ptr+k) << 14,p = 1; p<=ORDER ; p++){

accb += ((*(vtd->a+p)) * (*(vtd->x+ORDER−p+1)));
acc += (((I32)(*(vtd->a+p))) << 16) + 32768;
*(vtd->a+p) = (acc >> 16);
acc =−((vtd->errLms) *(*(vtd->x+ORDER-p−1)));

}
accb = accb > ((1 << 25) − 1) ? ((1 << 25) − 1) : accb;
accb = accb < (−(1 << 25) + 1) ? (−(1 << 25) + 1): accb;
sqNorm += (I32)(*(vtd->x+11)*(*(vtd->x+11)))−((I32)(*(vtd->x))*(*(vtd->x)));
for(p = 1;p<=ORDER; p++){

*(vtd->x+p−1) = *(vtd->x+p);

}

}
else{

acc = 0;
for(i = 0; i < ORDER; i++){

acc += (*(vtd->x+i)) * (*(vtd->x+i));

}
sqNorm = acc;

```
}
/*
  * If Prey Last and Last and current and Next not absent then
  */
if(!(rmsFlag[j] && rmsFlag[j+1] && rmsFlag[j+2] && rmsFlag[j+3])){
```

accb = 0;

}
else{

acc = ((accb>>11)/(1+(sqNorm>>15)));
acc <<= 11;
acc = acc < 32767 ? acc : 32767;
vtd->errLms = acc > −32767 ? acc : −32767;
accb >>= 10;
acc = msx[j];
normSh = acc >> 10;
acc = (msx[j] * accb) >> 8;
acc = (accb * acc) >> 6;
errRms[j] += acc >> 10;

}
vtd->prevVal = *(vtd->src_ptr + k);

}
for(j = 0;j<8;j++){

errnt = errRms[j];
errRms[j] = 0;
if(errnt> 750){

vtd->errCnt++;
vtd->flag = 1;

}

if((vtd->errCnt == 1) && vtd->flag){
vtd->sampleCnt = 1;
vtd->flag = 0;

}

}
vtd->rmsFlag0 = rmsFlag[8];
vtd->rmsFlag1 = rmsFlag[9];
vtd->sqNormH = (I16)(sqNorm >> 16);
vtd->sqNormL = (U16)(sqNorm & 0x0000ffff);
if(vtd->errCnt> 18 && vtd->blockActive > 16){

return(1);

}
return(0);

}

In its Magnesium™ product, Globespan Virata™ Corporation of Santa Clara, Calif., extends the benefits of integrated software on silicon (ISOS™)—pre-integrated software, pre-packaged systems, selectable software modules, system flexibility, all leading to rapid and low risk developments—to the voice processing market, providing a bundle of functions and interface drivers—vCore™—together with C54-compatible Digital Signal Processing (DSP) chips, such as those manufactured by Texas Instruments™. This product may be targeted for telecommunications equipment, such as broadband Integrated Access Devices (IADs), Private Branch Exchange's (PBX's), key systems, wireless base stations, and IP Phones. This combination of hardware and software is ideally suited to MIPS-intensive voice and telephony algorithms and may include VoDSL and VoIP applications.

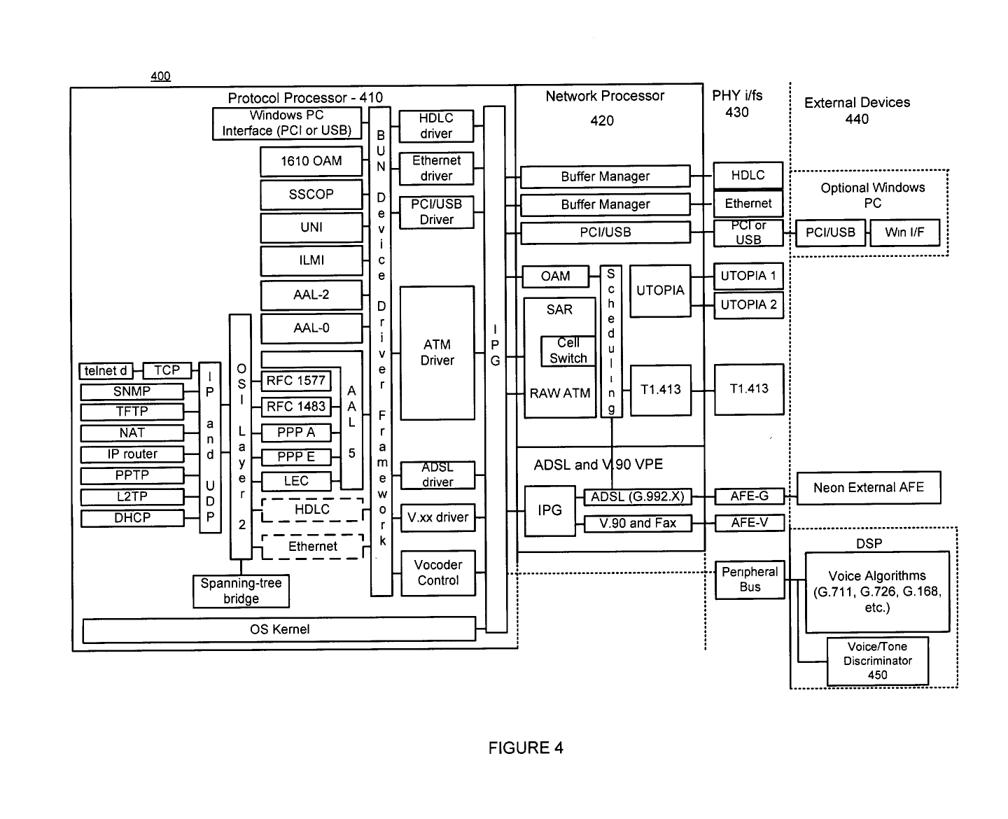

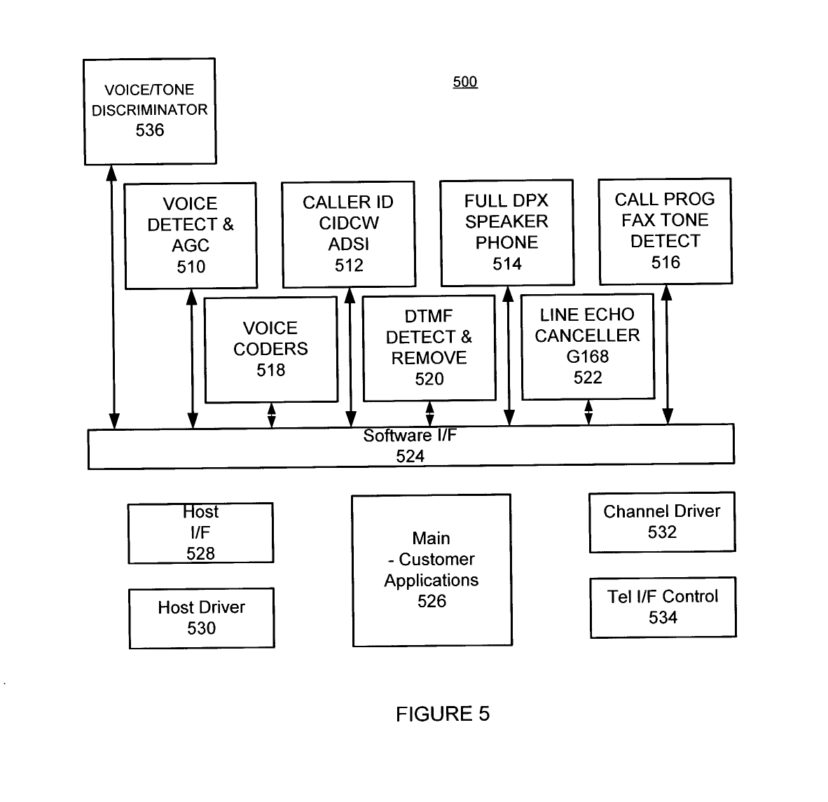

The inventive concepts discussed above may be incorporated into Application-Specific Integrated Circuits (ASICs) or chip sets such as Globespan Virata Corporation's Magnesium™ DSP chip, which may be used in a wide variety of applications. FIGS. 4 and 5 illustrate a hardware/software architectures 400 and 500 in which the present invention may be incorporated. The system of FIG. 4 includes a protocol processor 410, a network processor 420, physical interface section 430, and external device section 440, as well as software to implement the desired functionality. As shown in FIG. 4, a Voice/Tone Discriminator function 450 may be implemented as a voice algorithm or other software.

The system of FIG. 5 includes a software interface 524, in communication with a variety of modules and/or applications, which may include a voice detection and automatic gain control (AGC) module 510, a caller identifier on call waiting (CIDCW) analog display services interface (ADSI) module 512, a full duplex speaker phone module 514, a call progress fax tone detection module 516, a voice coders module 518, a Dual Tone Multi-Frequency (DTMF) detect and remove module 520, and a line echo canceller module 522. A voice/tone discriminator module 536 may be provided, in accordance with the present invention. In addition, other functionality may be provided by customer applications 526, a host interface (e.g., Helium™ host interface) 528, a host driver 530, a channel driver 532 and a telephone interface control 534. Other applications, modules and functionality may also be implemented.

Globespan Virata's Magnesium™ voice software, vCore™, is an object and source code software library proven in hundreds of applications around the world. Based on an open, flexible, and modular software architecture, vCore™ enables a system designer to provide an optimized and efficient custom solution with minimal development and test effort. Software modules associated with vCore™ are available for a wide range of applications including telephony functions, network echo cancellers, fax/data functions, voice coders and other functions.

Telephony functions that may be incorporated in the system include DTMF—Dual Tone Multi-Frequency generation and removal; MFD—Multi-Frequency Tone Detection; UTD—Universal Call Progress Tone Detection; FMTD—FAX and Modem Tone Detection Tone Generator—single, dual, and modulated; and VAGC—Voice Activity Detection with Automatic Gain Control. Network Echo Cancellers may include International Telecommunication Union (ITU) G.168—multiple reflector (up to 128 ms tail) and ITU G.168—single reflector (up to 48 ms tail). Fax/Data functions that may be incorporated in the system include caller ID, caller ID with call waiting, fax relay of T.38 and I.366.2, HDLC transmit/receive, and full-duplex speaker phone. Voice coders may include G.726, G.728—low delay coders; G.729, G.729A, G.729B, G.729AB, G.729E; G.723.1, G.723.1A; Global System for Mobile Communication GSM-EFR, GSM-AMR; G.722.1—audio coders; and proprietary coders.

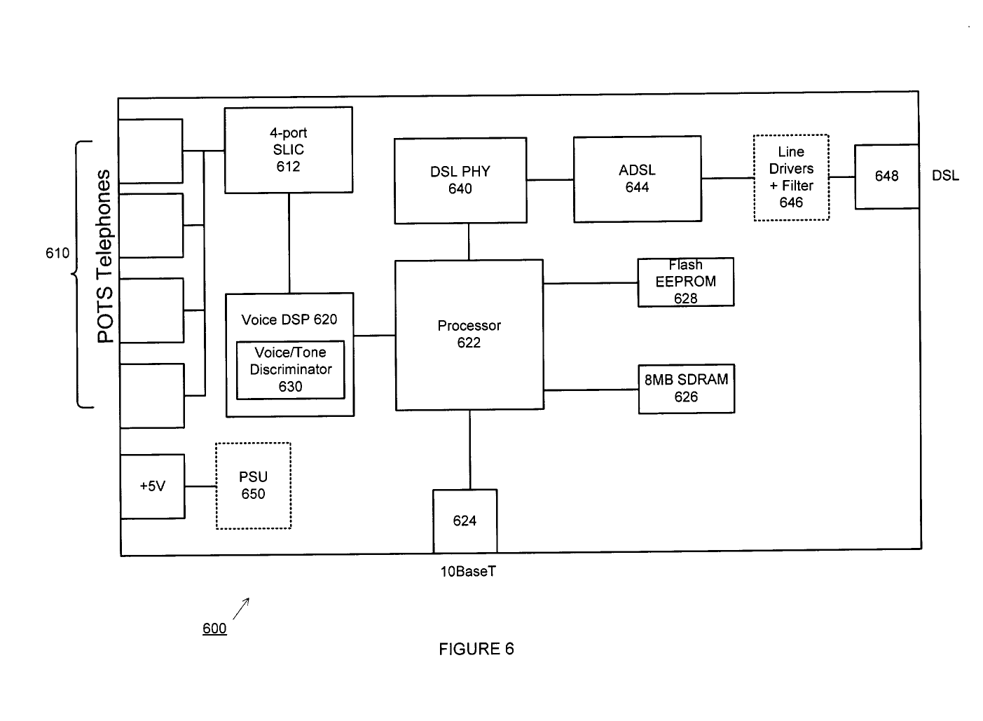

Referring to FIGS. 6-8, Voice-over-DSL integrated access devices (IADs) often require the integration of a broad range of complex technologies, including: Asynchronous Transfer Mode (ATM), packet, bridging, IP, and routing networking; real-time, toll-quality, voice traffic processing; voice encode/decode, echo cancellation, DTMF and other algorithms; and voice control and public-telephone-system interworking protocols. These technologies impose silicon and software requirements, and require a high degree of integration to achieve seamless operation.

Globespan Virata's Azurite™ chipsets, for example, are integrated voice and data solutions targeted at DSL Integrated Access Devices (IADs). These chipsets significantly increase performance, lower cost and speed time to market by integrating the Voice-over-DSL system components. Globespan Virata's Azurite™ 3000-series chipset features Globespan Virata's Magnesium™ DSP, Helium™ communications processor, and full software stack. Globespan Virata's PHY (e.g., physical layer device) neutral Helium™ communications processor may be used with any external Digital Subscriber Line Physical Layer Device (DSL PHY), whether xDSL, Asymmetric Digital Subscriber Line (ADSL), Symmetric Digital Subscriber Line (SDSL), or other, making the 3000-series suitable for a broad range of DSL IADs. Globespan Virata's Azurite™ 4000-series chipset features Globespan Virata's Magnesium™ DSP, Beryllium™ communications processor, and full software stack. Globespan Virata's Beryllium™ communications processor includes a built-in ADSL PHY, enabling the 4000-series to achieve the very highest level of integration for ADSL IADs.

In one embodiment, the present invention may be incorporated in components used in DSL Central Office (CO) Equipment. CO equipment often comprises high performance processors with built-in peripherals and integrated communications protocol stacks directed to a variety of Central Office (CO) equipment applications. For instance, one possible application for the inventive solutions in Central Office/Digital Loop Carrier (CO/DLC) environments involves a Digital Subscriber Line Access Multiplexer (DSLAM) line card. For instance, Globespan Virata's Helium™ processor and ISOS software can be used to concentrate up to seven double-buffered (fast and interleaved path) ADSL ports or alternatively up to 13 single-buffered (interleaved path only) ports, assuming in both cases a double-buffered port facing upstream or connected to a backplane in DSLAM or miniSLAM applications. Helium™ uses a high speed UTOPIA 2 interface can support a variety of different DSL PHY devices, e.g., ADSL, SHDSL (single-line high-bit-rate digital subscriber line or symmetrical high-density digital subscriber line), etc. Multiple devices can be used together to support line cards with greater numbers of ports. The Helium™ processor may be booted from either local memory or remotely from a central processor/memory.

The software provided may support a variety of Asynchronous Transfer Mode (ATM) functions such as Operations and Management (OAM), priority queuing, traffic shaping (constant bit rate (CBR), real time (rt)—variable bit rate (VBR), non real time (nrt)—VBR, policing (cell tagging) and congestion management (Early Packet Discard (EPD), Partial Packet Discard (PPD)). In the control plane, the Helium™ processor comes with a Q.2931 call processing agent which sets up switched virtual circuits (SVCs) within which associate the assigned ATM label Virtual Path Identifier/Virtual Channel Identifier (VPI/VCI) to a physical T1 Wide Area Network (WAN) port. In the management plane, Helium™ comes with a simple network management protocol (SNMP) agent which can be used by Element Management to configure or monitor the performance of the module, for example, detecting out of service events due to link failure, maintaining and reporting cyclic redundancy check (CRC) error counts, etc.

In another example, Globespan Virata's Helium™ processor is used to support protocol conversion between ATM and Frame Relay. Such an adaptation could be used in a DSLAM or ATM switch to transport data to an Internet Service Provider (ISP), for example over a Frame Relay network. ATM cells from the switch backplane are received by Helium™ via the UTOPIA-2 interface and converted into an AAL-5 (Protocol Data Unit) PDU. The resulting PDU is encapsulated into a High Level Data Link Control (HDLC) header with a Data Link Connection Identifier (DLCI) to complete the conversion into Frame Relay. The process is reversed in the other direction as indicated in the protocol stacks diagram. In the control plane, Helium™ comes with a Q.2931 call processing agent which sets up SVCs within which associate the assigned ATM label (VPI/VCI) to a physical T1 WAN port. In the management plane, Helium™ comes with a SNMP agent which can be used by Element Management to configure or monitor the performance of the module, for example, detecting out of service events due to link failure, maintaining and reporting CRC error counts, etc.

In yet another example, Globespan Virata's Helium™ processor is used in the design of an Inverse Multiplexing over ATM (IMA) line card for an ATM edge switch or miniSLAM. Helium™'s UTOPIA ½ interface supports up to 14 separate devices. The software supports traffic management functions such as priority queuing, traffic shaping and policing. During congestion, for example, low priority cells (Cell Loss Priority (CLP)=1) are either delayed or discarded to make room for high priority and delay intolerant traffic such as voice and video. Or alternatively, EPD (Early Packet Discard) may be invoked to discard all cells that belong to an error packet. In the control plane, Helium™ comes with a User Network Interface (UNI) 3.0/4.0 signaling stack for setting up and taking down SVCs. In the management plane, Helium™ comes with an SNMP agent and Telnet application that can be used by Element Management to configure or monitor the performance of the IMA module.

FIG. 6 illustrates an example of DSL Home/Office Routers and Gateways Hardware. As shown in FIG. 6, IAD 600 includes standard telephony jacks 610 whereby a standard telephone line is connected to a Voice DSP via a Codec/SLIC (Serial Line Interface Circuit) 612. This may occur locally, such at a Private Branch Exchange (PBX) or Small Office/Home Office (SOHO) gateway as often used in home office and small business situations, or can occur remotely at a central office. The SLIC 612, such as a four-port SLIC, may be connected to a Voice DSP 620, which may support voice/tone discriminator functionality, as shown by 630. The Voice DSP (e.g., Magnesium™ processor) 620 and the higher level, such as ATM, information processing and packetization processor reside at the central office or at the PBX/gateway. Voice DSP 620 may be connected to a processor (e.g., Helium™ processor) 622. Globespan Virata's Helium™ processor is a single chip, highly integrated ATM switching and layer ⅔processing device. Helium™ further includes a network processor that controls the direct connections to Ethernet and Universal Serial Bus (USB), as well as other physical interfaces. For example, Helium™ processor 622 may be connected to 10BaseT 624, Synchronous Dynamic Random Access Memory (SDRAM) 626, Electrically Erasable Programmable Read Only Memory (EEPROM) 628, DSL PHY 640, as well as other interfaces. DSL PHY 640 may also be connected to ADSL 644, which may be connected to Line Drivers and Filter 646. An interface to DSL may be provided at 648. In addition, a power supply unit may be provided at 650, which may support +5 volts (V) or other amount.

Voice data compression and encoding can be accomplished using Globespan Virata's G.729-Annex B and G.729A-Annex B, Conjugate-Structure Algebraic-Code-Excited Linear-Predictive (CS-ACELP) voice coder algorithms. Globespan Virata's G.729A-Annex B CS-ACELP voice coder algorithm module implements the ITU-T G.729-Annex A and Annex B voice coder standard. Annex B to G.729A defines a voice activity detector and comfort noise generator for use with G.729 or G.729A optimized for V.70 DSVD (Digital Simultaneous Voice and Data) applications. It compresses Codec (coder/decoder) or linear data to 8 KBps code using the Conjugate-Structure Agebraic-Code-Excited Linear-Predictive Coding function. Globespan Virata's G.729-Annex B CS-ACELP voice coder algorithm module implements the ITU-T G.729-Annex B voice coder standard. Annex B to G.729A defines a voice activity detector and comfort noise generator for use with G.729 or G.729A optimized for V.70 DSVD applications. It compresses Codec or linear data to 8 KBps code using the CS-ACELP coding algorithms.

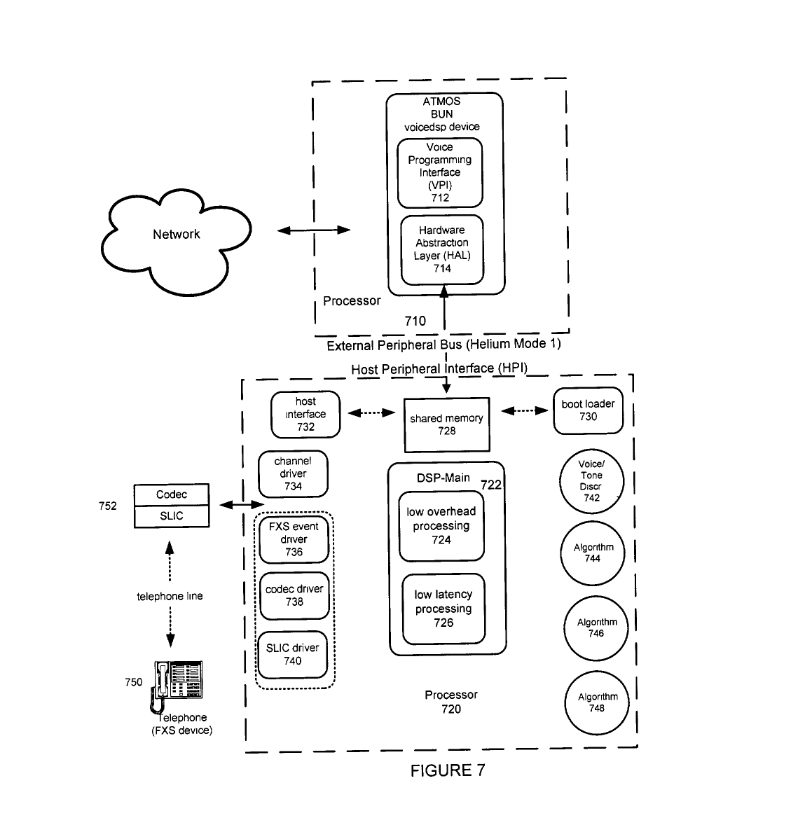

FIG. 7 illustrates a software architecture, according to an embodiment of the present invention. DSP-Main 722 application may be implemented to handle system-level data flow from an audio channel to a host processor via a host interface layer (HST). In particular, DSP-Main 722 may support low overhead processing 724 and low latency processing 726, as well as other types of processing. A FXS driver 736 (TFXS) handles state transitions and signal debouncing for the FXS event interface. The lower layers include device drivers for codec 738, SLIC 740, and a channel (or device) driver 734 for the audio channel (CNL). A boot loader 730 may load the DSP image after startup. The system provides a combination of minimal overhead, minimal CPU utilization, minimal latency and ease of integration, among other features.

FIG. 7 illustrates a processor (e.g., Globespan Virata's Helium™ processor) 710 connected to another processor (e.g., Globespan Virata's Magnesium processor) 720, which is connected to a telephone 750 or other device via Codec/SLIC 752. Processor (e.g., Helium™ processor) 710 may support a voice programming interface 712 as well as a hardware abstraction layer 714. Other functionalities may be supported by processor 710. Processor (e.g., Magnesium™ processor) 720 may include shared memory 728, boot loader 730, host interface 732, various algorithms (e.g., voice/tone discriminator 742) 742-748, various drivers (e.g., 734-740) as well as other functions.

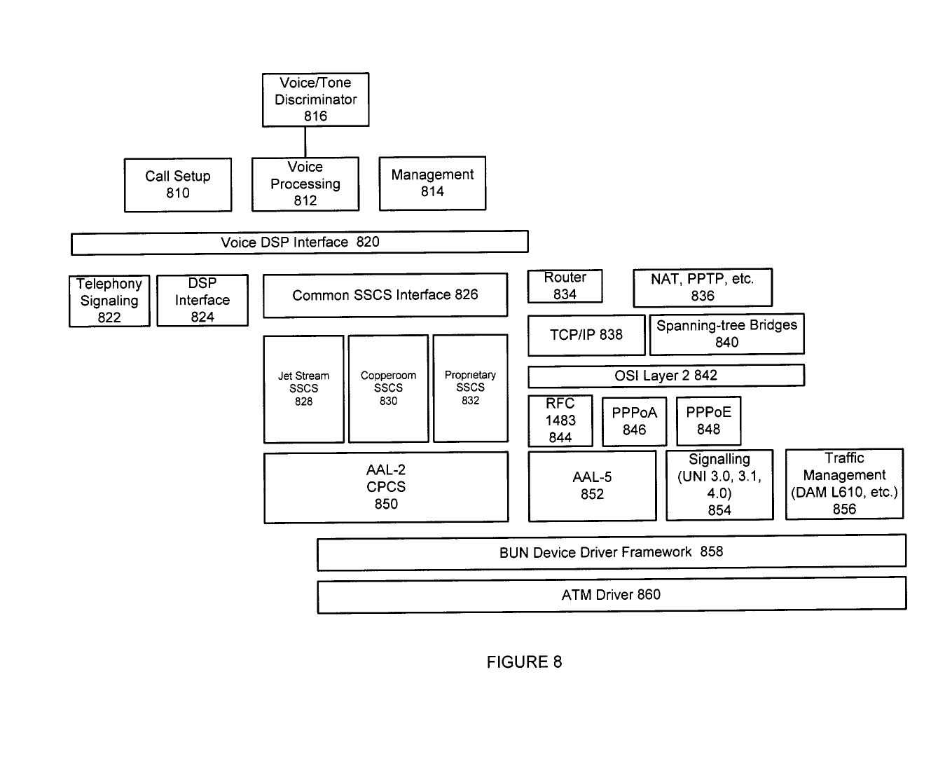

FIG. 8 illustrates a DSL integrated access device software, according to an embodiment of the present invention. As shown in FIG. 8, voice DSP software may include call setup 810, voice processing 812, and management 814. Other voice software may be provided. Voice/tone discriminator functionality, as shown by 816, of the present invention may be supported by the voice processing function at 812. Voice DSP Interface 820 provides an interface between voice DSP software and communications processor software. Communications processor software may include telephony signaling 822, DSP interface 824, Common Service Specific Convergence Sublayer (SSCS) Interface 826, Jet Stream SSCS 828, Copperoom SSCS 830, Proprietary SSCS 832, Router 834, Network Address Translation (NAT), Point to Point Tunneling Protocol (PPTP) 836, Transmission Control Protocol on top of the Internet Protocol (TCP/IP) 838, Spanning-tree bridge 840, Open Systems Interconnection (OSI) Layer 2 842, Request for Comments (RFC) 844, Point to Point Protocol over ATM (PPPoA) 846, Point to Point Protocol over Ethernet (PPPoE) 848, ATM Adaptation Layer (AAL)-2 Common Part Convergence Sublayer (CPCS) 850, ATM Adaptation Layer (AAL)-5 852, Signaling 854, Traffic Management 856, Broadband Unified Framework (BUN) device driver framework 858, ATM Driver 860, and/or other functionality.

Data encapsulation functionality may be provided by various methods, including RFC 1483, as shown by 844; PPPoA 846 and PPPoE 848, for example. Encapsulations, as well as the logical connections below them, may be treated generically. For example, encapsulations may be attached to the Spanning-tree bridge 840 or IP router 834. An end result may include the ability to easily route or bridge between ports with traditional packet interfaces and ports with encapsulations or simply between ports with encapsulations. RFC 1483, as shown by 844, provides a simple method of connecting end stations over an ATM network. PPPoA 846 enables user data to be transmitted in the form of IP packets. In one example, PPPoE 848 encapsulation may be used to transport PPP traffic from a personal computer (PC) or other device to a DSL device over Ethernet and then over a DSL link using RFC 1483 encapsulation. A PPPoE relay agent may act as bridge for determining on which session locally originated PPPoE traffic belongs.

AAL-2 (e.g., 850) may be used for transporting voice traffic. AALs may include at least two layers. A lower layer may include a CPCS for handling common tasks such as trailer addition, padding, CRC checking and other functions. An upper layer may include a SSCS for handling service specific tasks, such as data transmission assurance. AAL-5 (e.g., 852) may provide efficient and reliable transport for data with an intent of optimizing throughput and perform other functions.

AAL 5 852 is a type of ATM adaptation layer for defining how data segmentation into cells and reassembly from cells is performed. Various AALs may be defined to support diverse traffic requirements.

Signaling 854 may provide a means for dynamically establishing virtual circuits between two points. Spanning-tree bridges 840 may provide a transparent bridge between two physically disjoint networks with spanning-tree options. A spanning-tree algorithm may handle redundancies and also increase robustness.

BUN device driver framework 858 provides a generic interface to a broad range of packet and cell-based hardware devices. BUN may be termed a device driver framework because it isolates hardware-independent functions from hardware-dependent primitives and, in doing so, simplifies device driver development, maintenance and debugging.

ATM Driver 860 passes data between application software tasks and a physical ATM port, for example, ATM Driver 860 may perform ATM cell segmentation and reassembly, AAL encapsulation, and multiplexes concurrent data streams.

While the foregoing description includes many details and specificities, it is to be understood that these have been included for purposes of explanation only, and are not to be interpreted as limitations of the present invention. Many modifications to the embodiments described above can be made without departing from the spirit and scope of the invention.

The present invention is not to be limited in scope by the specific embodiments described herein. Indeed, various modifications of the present invention, in addition to those described herein, will be apparent to those of ordinary skill in the art from the foregoing description and accompanying drawings. Thus, such modifications are intended to fall within the scope of the following appended claims. Further, although the present invention has been described herein in the context of a particular implementation in a particular environment for a particular purpose, those of ordinary skill in the art will recognize that its usefulness is not limited thereto and that the present invention can be beneficially implemented in any number of environments for any number of purposes. Accordingly, the claims set forth below should be construed in view of the full breath and spirit of the present invention as disclosed herein.

1. A method for discriminating voice from tone, the method comprising the steps of:
receiving an input signal;
generating a prediction signal for modeling a signal wherein the signal is one of a tone signal and a speech signal;
comparing the input signal and the prediction signal;
generating an error signal based on the input signal and the prediction signal; and
detecting a voice signal when the error signal is above a predetermined threshold value.

2. The method of claim 1 further comprising the steps of:
determining a duration associated with the error signal; and
determining whether the duration is above a predetermined time threshold for detecting the voice signal.

3. The method of claim 2, wherein the predetermined time threshold is approximately 128 milliseconds.

4. The method of claim 1, further comprising the step of:
determining a start of the voice signal.

5. The method of claim 1, wherein the error signal is a normalized error signal.

6. The method of claim 1 further comprising the step of:
distinguishing a noise signal from the input signal.

7. The method of claim 6, further comprising the step of:
implementing a noise floor of approximately 6 dB.

8. The method of claim 1, wherein the step of generating an error signal further comprises the steps of:
calculating a normalized mean square error value for each sample for each subframe, and
accumulating the normalized mean square error value for each sample for generating the error signal.

9. The method of claim 8, wherein each subframe comprises approximately 8 samples.

10. The method of claim 1, wherein the step of generating a predicted signal further comprises the step of:
implementing a normalized least mean square function.

11. The method of claim 1, wherein the error signal is computed as:
e′(n)=e(n)/rms(xₖ₋₁ . . . x_{k-M})
wherein e(n) is represented by d(n)−w(n)^{T}u(n), where d(n) represents a desired response, where w(n) represents predictor coefficients; where u(n) represents an input vector at time n where the input vector comprises xₖ₋₁ . . . x_{k-M}, and where M represents a number of taps.

12. The method of claim 11, wherein w(n+1) is represented by w(n)+μu(n)e*(n)/(a+∥u(n)∥²) where μ represents an adaptation constant; where a represents a positive constant.

13. A system for discriminating voice from tone, the system comprising:
a filter for receiving an input signal;
a prediction filter for generating a prediction signal for modeling a signal wherein the signal is one of a tone signal and a speech signal;
a module for comparing the input signal and the prediction signal and for generating an error signal based on the input signal and the prediction signal;
wherein a voice signal is detected when the error signal is above a predetermined threshold value.

14. The system of claim 13 wherein the module determines a duration associated with the error signal and determines whether the duration is above a predetermined time threshold for detecting the voice signal.

15. The system of claim 14, wherein the predetermined time threshold is approximately 128 milliseconds.

16. The system of claim 13, where a start of the voice signal is determined.

17. The system of claim 13, wherein the error signal is a normalized error signal.

18. The system of claim 13, wherein the filter distinguishes a noise signal from the input signal.

19. The system of claim 18, wherein the filter implements a noise floor of approximately 6 dB.

20. The system of claim 13, wherein the module calculates a normalized mean square error value for each sample for each subframe, and accumulates the normalized mean square error value for each sample for generating the error signal.

21. The system of claim 20, wherein each subframe comprises approximately 8 samples.

22. The system of claim 13, wherein the prediction filter implements a normalized least mean square function.

23. The system of claim 13, wherein the error signal is computed as:
e′(n)=e(n)/rms(xₖ₋₁ . . . x_{k-M})
wherein e(n) is represented by d(n)−w(n)^{T}u(n), where d(n) represents a desired response, where w(n) represents predictor coefficients; where u(n) represents an input vector at time n where the input vector comprises xₖ₋₁ . . . x_{k-M}, and where M represents a number of taps.

24. The system of claim 23, wherein w(n+1) is represented by w(n)+μu(n)e*(n)/(a+∥u(n)∥²) where μ represents an adaptation constant; where a represents a positive constant.

25. The system of claim 13 wherein the prediction filter is an adaptive prediction filter.
